(19) United States
(12) Patent Application Publication
(10) Pub. No.: US 2022/0027333 A1
(43) Pub. Date: Jan. 27, 2022

(54) A System, Method and Data Structure for Allowing Users to Electronically Post Comments

(71) Applicant: TipeME Holdings Pty Ltd, Birkdale (AU)

(72) Inventor: Shane Isaac, Birkdale (AU)

(21) Appl. No.: 17/312,063

(22) PCT Filed: Dec. 9, 2019
(86) PCT No.: PCT/AU2019/051346

§ 371 Date: Jun. 9, 2021

(30) Foreign Application Priority Data
Dec. 10, 2018 (AU) 2018904690

(51) Int. Cl. G06F 16/21; G06F 16/23; G06Q 50/00; H04L 12/58

(52) U.S. Cl. CPC G06F 16/219; H04L 51/32; G06Q 50/01; G06F 16/2358

(57) ABSTRACT

A system for allowing users to electronically post respective comments with user devices, where each comment relates to an item of posted content. The system includes an interface for receiving posted comments and requests for selected posted data. The interface directs the selected posted data to devices in response to the respective requests from those devices. The system also includes a database for storing content data for each item of posted content, a count engine responsive to the interface receiving comments from the user devices, and a publishing engine responsive to requests for accessing data to generate the selected posted data. Associated methods for allowing users to electronically post respective comments with user devices are also disclosed.

### FIELD OF THE INVENTION

The present invention relates to a system, method and data structure for allowing users to electronically post comments.

The invention has been developed specifically for use with social media platforms for mobile devices and will be described hereinafter with reference to that application. However, it will be appreciated that the invention is not limited to that particular field of use and is also applicable to social media platforms for non-mobile devices, whether those platforms are public or private, or both.

### Discussion of the Prior Art

Any discussion of the prior art throughout the specification should in no way be considered as an admission that such prior art is widely known or forms part of common general knowledge in the field.

With the widespread use and popularity of social media platforms there have been considerable efforts made to enhance the functionality offered to users to comment upon content posted on those platforms. This includes functionality such as allowing user to “like” or “dislike” posted content with a single click of a corresponding icon that is published with the content. Such platforms can also offer users the ability to comment in more complex ways by posting in respect of the content one or more of text, images, icons (such as emoticons) or other such devices.

For public platforms the comments are typically posted partially or fully anonymously by the users, in that the only identification provided is a handle and/or an avatar adopted by the user posting the comment. For more straightforward comments, such as a thumbs-up or thumbs-down, the comments are, effectively, fully de-identified for users.

For social media platforms that are social networking platforms, the identities of the users posting content and comments are more likely to be known to each other. Accordingly, there are typically provided separate functionalities for allowing users to make attributed and unattributed comments in relation to each item of posted content.

As the number of users on a given platform grows the computing demands placed upon the server-side of the platform (as distinct from the client-side defined by the user devices) rapidly increases. While this is particularly exacerbated for those platforms accommodating multiple forms of comments, is also problematic for even relatively simple forms of comments such as the thumbs-up and thumbs-down style comments. The typical processing bottlenecks include: updating a database with the most recently made comments; and subsequently accessing that database to generate the most up-to-date data for the users. While this problem may be ameliorated temporarily through deploying more computing power on the server-side of the platform, a rapid rise in user numbers, coupled with the demand from the platforms for real-time updates and many additional complex functionalities, has resulted in an ongoing technical issue to address for such platforms.

Accordingly, there is a need for improved systems, methods and data structures for allowing users to electronically post comments.

### SUMMARY OF THE INVENTION

It is an object of the preferred embodiments of the present invention to overcome or ameliorate at least one of the disadvantages of the prior art, or to provide a useful alternative.

According to a first aspect of the invention there is provided a system for allowing first users to electronically post with first user devices respective comments relating to posted content provided by a second user with a second user device, the system including:
an interface for:
   receiving: the posted content from the second user device; the comments from the respective first user devices; and requests from the user devices for selected posted data; and
   allowing the selected posted data to be directed to the user devices in response to the respective requests from those devices;
a database for storing: content data that is derived from the posted content, wherein the content data includes a content field that is indicative of the content and a count field for storing count data; and comment data that is derived from the comments;
a count engine that is responsive to the interface receiving comments from the respective first user devices for selectively: determining a count of the comments made by the first users; and updating the count field to be indicative of the count; and
a publishing engine that is responsive to the requests for selected posted data accessing the content data and the comment data to generate the selected posted data.

In an embodiment the count engine updates the count field to be the count of the comments.

In an embodiment each comment has a comment type that is selected from a predetermined list of comment types and the count engine updates the count data to indicate the number of the comments of at least one of the comment types.

In an embodiment the count engine updates the count data to indicate the number of the comments of each comment type selected.

In an embodiment the count engine updates the count data to indicate the number of the comments of each comment type.

In an embodiment the system includes a comment engine that is responsive to the interface receiving a posted comment from one of the first users in respect of the posted content for:
accessing the database and being responsive to the comment data and/or the content data to ascertain if the one of the first users has an existing comment for the posted content;
if so, comparing the posted comment and the existing comment; and
if the posted comment and the existing comment vary, updating the comment data and the count data.

According to a second aspect of the invention there is provided a method for allowing first users to electronically post respective comments relating to electronically posted content of a second user, the method including the steps of:
providing an interface for receiving the content from the second user and the comments from the respective first users and for allowing the users to access posted data;
storing in a database: content data that is derived from the content, wherein the content data includes a content field that is indicative of the content and a count field for storing count data; and comment data that is derived from the comments;
being responsive with a count engine to the interface receiving comments from the respective first users for selectively: determining a count of the comments made by the first users; and updating the count field to be indicative of the count; and
using a publishing engine that is responsive to the content data and the comment data for generating the posted data.

In an embodiment the method includes the step of the count engine updating the count field to be the count of the comments.

In an embodiment each comment has a comment type that is selected from a predetermined list of comment types and the method includes the step of the count engine updating the count data to indicate the number of the comments of at least one of the comment types.

In an embodiment the method includes the step of the count engine updating the count data to indicate the number of the comments of each comment type selected.

In an embodiment the method includes the step of the count engine updating the count data to indicate the number of the comments of each comment type.

In an embodiment the method includes the step of providing a comment engine that is responsive to the interface receiving a posted comment from one of the first users in respect of the content for:
accessing the database to ascertain if the one of the first users has a previously posted comment on the content; and
if so, ascertaining if the posted comment and the previously posted comment vary; and
if so, updating the comment data and the count data.

According to a third aspect of the invention there is provided a data structure for allowing first users to provide respective comments relating to content provided by a second user, the data structure including:
a content field that is indicative of the content provided by the second user; and
a count field associated with the content field for storing count data indicative of a count of the comments made by the first users.

In an embodiment the count data is derived from the number of the comments.

In an embodiment each comment has a comment type that is selected from a predetermined list of comment types and the count data is derived from the number of the comments of at least one of the comment types.

In an embodiment the count data is derived from the number of comments of all the comment types.

In an embodiment the comment type for a comment is selected by the respective first user.

In an embodiment the count data is indicative of up to a maximum of one comment each for the respective first users.

In an embodiment the count field is updated in response to one of the first users providing a respective comment.

According to a fourth aspect of the invention there is provided a system for allowing users to electronically post respective comments with user devices, wherein each comment relates to one of a plurality of items of posted content and the system includes:
an interface for:
   receiving from the user devices: the comments; and requests for selected posted data; and
   allowing the selected posted data to be directed to the user devices in response to the respective requests from those devices;
a database for storing: content data for each item of posted content that is indicative of the posted content for the respective items; and, for each of the comments, comment data that is indicative of the comment and the user making the comment;
a comment engine that is responsive to the interface receiving comments from the respective users for selectively updating the comment data and the content data; and
a publishing engine that is responsive to the requests for selected posted data for accessing the content data to generate the selected posted data.

In an embodiment the content data includes count data and the comment engine is responsive to the interface receiving a comment from one of the users in respect of one of the items for: determining a count of the comments made by the users for that item; and updating the count data to be indicative of the count.

In an embodiment:
each comment has a comment type that is selected from a predetermined list of comment types; and
the comment engine updates the count data to be indicative of a count of the comments of at least one of the comment types.

In an embodiment the comment engine updates the count data to be indicative of a count of the comments of each comment type selected by the users in respect of the one of the items.

In an embodiment the count engine updates the count data to indicate a count of the comments of each comment type for the one of the items.

In an embodiment the comment engine is responsive to the interface receiving a new comment from one of the users in respect of one of the items of posted content for:
accessing the database to ascertain if the one of the users has provided an earlier comment in respect of the one of the items;
if so, comparing the new comment and the earlier comment; and
being responsive to the comparison for selectively updating the user data.

In an embodiment the comment engine is responsive to the comparison for selectively updating the count data.

According to a fifth aspect of the invention there is provided a method for allowing users to electronically post respective comments with user devices, wherein each comment relates to one of a plurality of items of posted content and the method includes the steps of:
providing an interface for:
   receiving from the user devices: the comments; and requests for selected posted data; and
   allowing the selected posted data to be directed to the user devices in response to the respective requests from those devices;
storing in a database: content data for each item of posted content that is indicative of the posted content for the respective items; and, for each of the comments, user data that is indicative of the comment and the user providing the comment;
being responsive to the interface receiving comments from the respective users for selectively updating the user data; and being responsive to the requests for accessing the content data and the user data to generate the selected posted data.

According to sixth aspect of the invention there is provided a data structure for allowing users to electronically post respective comments with user devices, wherein each comment relates to one of a plurality of items of posted content and the data structure includes:
content data for each item of posted content that is indicative of the posted content for the respective items; and
for each of the comments, user data that is indicative of the comment and the user making the comment.

In an embodiment the content data for each item includes count data that is indicative of a count of the comments made by the users for that item.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, importance, or in any other manner.

Unless the context clearly requires otherwise, in the claims below and the description herein, any one of the terms “comprising”, “comprised of” or “which comprises” is an open term that means “including at least the elements/features that follow, but not excluding others”. Thus, the term “comprising”, when used in the claims, should not be interpreted as being limitative to the means or elements or steps listed thereafter. For example, the scope of the expression “a device comprising A and B” should not be limited to devices consisting only of elements A and B. Any one of the terms “including” or “which includes” or “that includes” as used herein is also an open term that also means “including at least the elements/features that follow the term, but not excluding others”. Thus, the term “including” is synonymous with and means “comprising” and can be used interchangeably.

As used herein, the term “exemplary” is in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Preferred embodiments of the invention will now be described, by way of example only, with reference to the accompanying drawings in which:

FIG. 1 is a schematic representation of a system according to an embodiment of the invention;

FIG. 2 is a schematic representation of data structures used in the system of FIG. 1;

FIG. 3 is a flowchart illustrative of an exemplary operation of the system of FIG. 1; and

FIG. 4 is an illustrative sequence of screenshots from a user device accessing system 1.

### DETAILED DESCRIPTION OF THE PREFERRED EMBODIMENTS

Described herein are a system, method and data structure for allowing users to electronically post comments.

Social media platforms include social networking platforms, blogs, microblogs, video sharing platforms, internet forums, and the like. These internet or computer network enabled platforms allow for the sharing of digital content—being “posted content”—and typically also for users to provide comment on the content. In this context, it will be understood that a comment itself is able to be posted content upon which a further comment is able to be made. The digital content is able to include a wide variety or combination of elements and/or file types, including one or more of: text; one or more image files; one or more video files; hypertext of other links; and the like. The comments provided by users are also able to be selected from a wide array of options, including devices such as one or more of: an icon; a count; or any of the devices of the kind used in the posted content.

In the preferred embodiments of the invention the comments are exemplarily provided as “reactions” to content. These reactions are a subset of the broader term “comments” and are used in the embodiments described below to illustrate the operation of those embodiments and the advantageous functionalities that are able to be realised by the use of such reactions. However, in other embodiments, use is made of comments other than or in addition to the reactions that are described below.

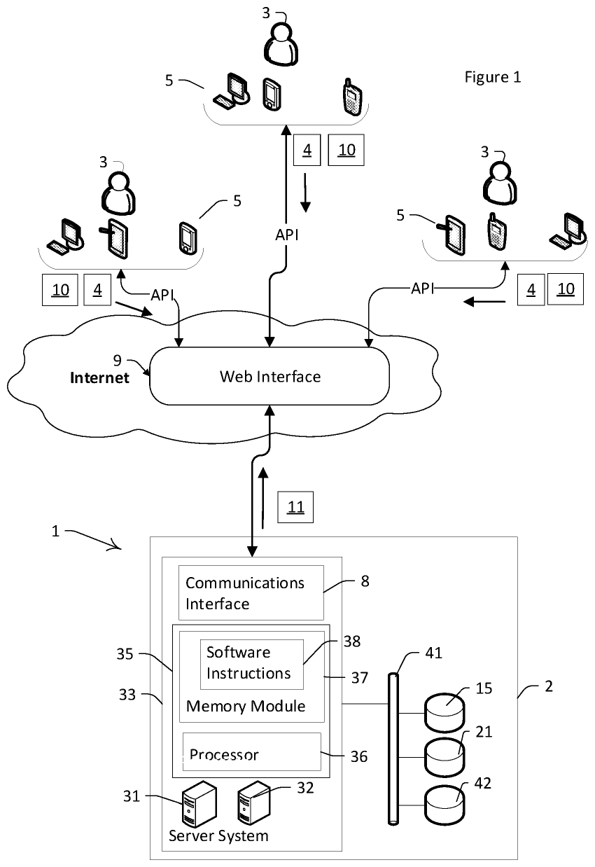

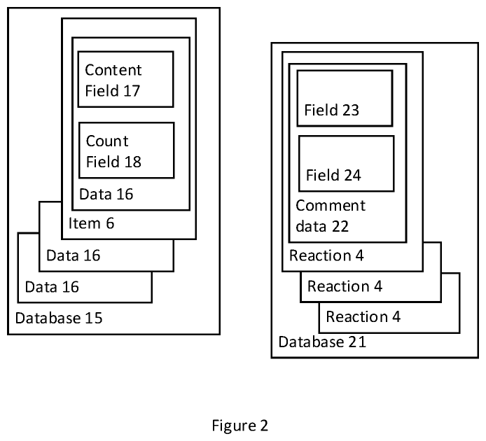

Referring to FIG. 1 and FIG. 2 there is illustrated a system 1 according to an embodiment of the invention. System 1 includes a facility 2 for hosting a social media platform in the form of a social networking platform. System 1 allows users 3 to electronically post respective comments, in the form of reactions 4, with user devices 5. Each reaction 4 relates to one of a plurality of items 6 (see FIG. 2) of posted content on the social networking platform. System 1 includes an interface, in the form of a communications interface 8 and a web interface 9, for receiving from devices 5 both reactions 4 and, separately, requests 10 for selected posted data 11 on the platform. Data 11 is able to be indicative of one or more of items 6 of posted content, reactions 4, or other posted material, or data derived from any of these and can include other data such as advertising and the like. Interface 8 directs the selected posted data 11 to devices 5 in response to the respective requests 10 from those devices. As best shown in FIG. 2, database 15 stores content data 16 for each item 6 of posted content. The content data 16 for a given item 6 includes a content field 17 that contains data indicative of the posted content for the item 6 and a count field 18. A database 21 stores, for each of reactions 4, comment data 22 that has a field 23 and a field 24 which contain respectively data indicative of the respective reaction and data indicative of the respective user 3 providing the reaction. A comment engine, in the form of reaction server 31, is responsive to interface 8 receiving reactions 4 from the respective users 3 for selectively updating data 22. A publishing engine, in the form of a publishing server 32, is responsive to requests 10 for accessing data 16 and 22 to generate the selected posted data 11.

Although only three users 3 are explicitly illustrated, it will be appreciated that the platform supports many hundreds of thousands or millions of users.

Facility 2 is controlled by an operator (not shown) that maintains the required hardware and software to allow the platform to function. In this embodiment, the operator is also the owner of data 16, which is predominantly authored by users 3. That is, system 1 allows the users to post reactions 4 in response to content earlier generated by other users or by the operator. System 1 also is able to treat a given reaction as content such that additional reactions are able to be subsequently posted in respect of the given reaction.

In other embodiments, the operator instead, or additionally, employs or otherwise engages one or more authors to generate the content data 16. In further embodiments, some of the content data 16 is derived from feeds such as news feeds or the like. That is, although in the embodiments described in detail system 1 is applied to a social networking platform, it will be appreciated by those skilled in the art that it is also applicable to other platforms such as blogs, collaborative management tools, online publishing and other online platforms that accommodate comments (that is, reactions) from users.

Devices 5 are internet enabled devices for allowing the users to interact with system 1. These include devices such as smartphones, tablets, desktop computer, laptop computers, and the like. A given user will typically initiate a session with system 1 via one such device at any given time. However, that user is able to use any other such device to initiate a later session and gain the same functionality from system 1.

Servers 31 and 32 included within system 1 are part of a server system 33 that operates to provide the functionality of system 1. An exemplary server 35 in system 33, which is an administration server for system 1, includes a processor 36, a memory module 37 for storing, amongst other things, software instructions 38 that are executed by server 35 to contribute to the overall functionality of system 1. Other servers are included to provide further functionality within system 1, as would be appreciated by those skilled in the art.

Server system 33 also makes use of a communications backbone 41 for allowing system 33 to access and/or update the records held in databases 15, 21 and 42, and any other databases that are included within facility 2. Insofar as system 1 requires data from remotely located or controlled databases, that is accessed via interface 8.

In other embodiments, some or all of data 16 and data 22 is stored in one or more databases (not shown) remotely located with respect to facility 2.

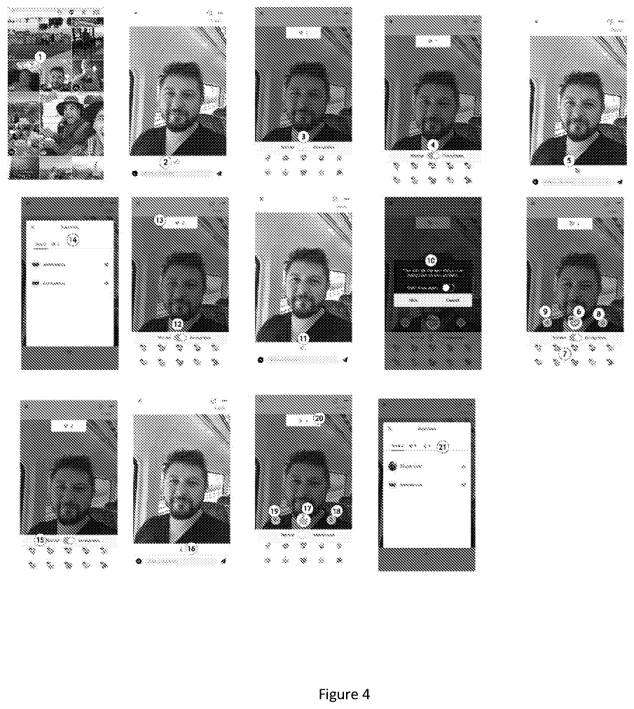

Although in FIG. 2 there are only explicitly illustrated three records each for data 16 and data 22, system 1 accommodates many millions of such records, and is configured for that number to continually grow as new content is posted and new reactions to that content arises though the operation of system 1. That operation will now be described in more detail with reference to the fourteen sequential screenshots of FIG. 4, where the reference numerals 1 to 21 inclusive are presented within respective circles that overlie the screenshots. These reference numerals are expanded upon as follows:
Screenshot 1, reference numeral 1—Each user 3 is logged into system 1 after successfully completing an enrolment process (not shown). Once logged into system 1, each user 3 is able to use device 5 to submit a request 10 and view posted data 11 that is made available for their selection. In some embodiments all data 16 is publicly available, while in other embodiments the users are self-arranged in groups to limit the access of given posted content. In FIG. 1, the posted content is designated by reference numeral 1 and includes a plurality of digital images uploaded by other users and which are available to the users to interact with. The images are arranged in chronological order with reference to the time of being posted to system 1. However, in other embodiments, a different ranking system is used, such as perceived interest to the user, the date of creation of the image, relevance of the image to user specified topics, and the like. In this instance, the user selects one of the images by clicking or tapping on the thumbnail provided. This results in a further request 10 being generated by device 5 and communicated to system 1.
Screenshot 2, reference numeral 2—Upon selecting the thumbnail, a more detailed format of the image is provided in a further instance of posted data 11. Once received by device 5, this higher resolution image is displayed to user 3 via the GUI of device 5. In doing so, the GUI also displays an interactive button or icon to user 3. If the user 3 taps this button once, then the user's pre-set default reaction will be communicated to system 1 in a respective reaction 4. If the user taps and holds this button, then additional reaction options will appear.
Screenshot 3, reference numeral 3—Following a hold interaction with the interactive button, the GUI of device 5 presents user 3 with a list of reaction types and options. In this example embodiment there are ten types of reactions listed for the user, and each reaction type presents a normal state and an anonymous state. The reaction 4 communicated to system 1 will be indicative of both the reaction type and the reaction state. If the user selects the normal state for any given reaction type, then the reaction 4 communicated to system 1 will include not only data indicative of the type of the reaction, but also that the reaction is to be recorded and displayed against the posted data 16 and associated with the specific user 3 generating reaction 4. Alternatively, user 3 is able to select the anonymous state by pressing a toggle switch.
Screenshot 4, reference numeral 4—From screenshot 3 the user 3 has switched to the anonymous state and each reaction icon is now presented with a label to differentiate from the normal status reactions. If the user 3 selects a reaction in the anonymous state, then the reaction is recorded and displayed against the post content and is not associated with the user 3 making the reaction. Another user, whether it be the owner of the posted content or another user viewing the post, will not be able to identify the user making the anonymous reaction.
Screenshot 5, reference numeral 5—In screenshot 4, the user 3 selected the anonymous “kiss” type of reaction, which is communicated to system 1 as a reaction 4. In screenshot 5 the user 3 who sent the reaction 4 is able to again access the posted content in respect of which the reaction was made and to view the results of reaction 4. That is, the user 3 making reaction 4 is able to gain confirmation of the reaction type that was selected to be made in respect of the posted content. When the user 3 taps on the reaction icon indicated by reference numeral 5, further options for interacting with the selected reaction type are made available to user 3.
Screenshot 6, reference numerals 6 to 9—At screenshot 5 the user 3 tapped an existing visible reaction icon. In screenshot 6 there is displayed the current reaction the user 3 has applied to the relevant posted content. The list of icons presented by reference numeral 7 correspond to the original list of reaction types and allow the user 3 to select from that list to change or confirm the reaction type and option. Moreover, it is possible for the user 3 to delete or remove the current reaction to the posted content, which in this embodiment is provided by selecting a delete icon indicated by reference numeral 8. Furthermore, the user 3 is also offered the option to hide the fact that he or she earlier submitted reaction 4 to the posted content. This functionality is enabled by user 3 pressing the icon indicated by reference numeral 9. This results in the visual confirmation supplied in screenshots 5 and 6 above reverting to a non-react status and otherwise eliminating any visual evidence of user 3 having submitted a reaction 4 to the relevant posted content. This allows user 3 in this example (and all users of system 1 in a more general sense) to react to posted content without another person, who may have access to the user's account on system 1, being able to detect the existence of reaction 4. That specific reaction 4 will still remain visible in the total list of reactions (see below).
Screenshot 7, reference numeral 10—At screenshot 6, user 3 selected the icon represented by reference numeral 9 and, as such, device 5 informs user 3 of the consequences of that selection. In particular, device 5 is configured to provide an informative pop-up 10 to notify user 3 that the relevant reaction is still active in system 1 but is not visible to user 3, even though legitimately logged in for use of system 1. In some embodiments, system 1 allows the user 3 the option of having the or all hidden records made visible again.
Screenshot 8, reference numeral 11—once the icons represented by numerals 9 and 10 have been sequentially selected, the user 3 will be presented with the posted content, together with the changed reaction. That is, the reaction that was previously visible (screenshot 5) is no longer visible at screenshot 7 (in that the area indicated by reference numeral 11 is the same as that provided in screenshot 2. If the user 3 taps and holds on the icon near reference numeral 11, device 5 executes locally held code to present to user 3 a screenshot 8.
Screenshot 9, reference numeral 12 and 13—Screenshot 9 is effectively visually identical to screenshot 3. However, at system 1, the total count of reactions (and of the reactions of each type) for the posted content includes a count of user 3's reaction as it is still active, although hidden. Moreover, if user 3 taps on the icon represented by the reference numeral 13, then details of the total reactions (in this embodiment, a count of the reaction of each type) is presented. In some embodiments, an update of the count information is provided to device 5 in response to the change in the reaction by user 3, while in other embodiments, the refreshed count data is only sought from system 1 by device 5 once user 3 selects icon 13.
Screenshot 10, reference numeral 14—As illustrated exemplary in this screenshot, for the given posted content there are presently two reactions, one which was provided by the user 3 at screenshot 4. While that comment is hidden to the user 3 that posted it, it is still counted.
Screenshot 11, reference numeral 15—After advancing from screenshot 14, the user 3 has returned to the view of screenshot 15. In this example, the user 3 switches the reaction status back to the normal status and reaction type to a “green thumbs up” reaction type.
Screenshot 12, reference numeral 16—The reaction status and type selected at screenshot 11 is displayed in screenshot 16. As before, the user 3 is able to tap and holds on icon 16 to view additional options for the status and type of reaction.
Screenshot 13, reference numerals 17 to 20—After confirming the change in the reaction status and type—or the change in any one of those—device 5 presents to user 3 an image as illustrated in screenshot 17. This displays the user's current reaction (status and type) for the relevant posted content. In this instance, the reaction status is normal and not anonymous. As before, user 3 has the ability to delete and/or remove the normal reaction status by using the icon represented by reference numeral 18. The functionality of icon 9 is also available to apply to normal reactions and is displayed in screenshot 13 as an icon represented by reference numeral 19. If user 3 taps icon 19 then the process of screenshots 6 and 7 will follow. Furthermore, user 3 is able to tap on the icon indicated by reference numeral 20 to view count data of reactions for the given posted content.
Screenshot 14, reference numeral 21. It should be noted that the previous anonymous reaction which was: applied at screenshot 4; hidden with screenshots 6 and 7; and viewed at screenshot 14 has been removed due to the newly applied normal reaction at screenshot 11. That is, the normal status reaction (being the latest change that has been made by the relevant user to the reaction type and/or status) is included in the count data and displayed with an indication of the identity of the user 3 what provided the reaction.

In the above embodiment, a given user has the ability to provide at any given time a maximum of one reaction for a given item of posted content. However, that reaction is able to be changed over time in one or more ways, including by changing one or more of the following characteristics: existence (that is, a reaction can be deleted); status; type; and visibility. Accordingly, the comments—that is, the reactions—enabled by system 1 present a dynamic environment for users to learn and adjust their respective reactions in response to new inputs. That is, the reactions are not static, but open to change as the relationship between the users change. To allow the above functionality to be effectively and efficiently delivered the preferred embodiments, including system 1, make use of specific data structures and data operations Examples of these are provided below.

### Recorded Reactions

A list of reaction types is required by system 1, and this is defined within system 1 to be, for example:

{

“like”:0,
“kiss”:0,
“surprise”:0,
“smile”:0,
“love”:0,
“flower”:0,
“cheer”:0,
“haha”:1,
“heart”:0,
“relax”:0

}

### Reaction Status Inside a Post

System 1 makes use of the following status types for reactions:
“reacted” defines the type of reaction selected by the user.
“reactionHide” defines the display status of the reaction, whether proof of the reaction is visually displayed on the logged in user's user interface
“ownerReacted” defines whether the post creator has reacted to their own post and the type of reaction selected by the owner
“ownerReactionHide” defines the display status of the post creator's reaction, whether proof of the reaction is visually displayed on the logged in instance of the post creator's user interface
“reactedAnonymous” defines whether the reaction has been marked as anonymous. If marked as anonymous the user's identification will not be displayed or associated with the reaction to other users

{

“reacted”:“haha”,
“reactionHide”:0, // 0 = false, 1 = true
“ownerReacted”:“haha”,
“ownerReactionHide”:0, // 0 = false, 1 = true
“reactedAnonymous”:0 // 0 = false, 1 = true

}

### Updating a Reaction

To allow for reactions to be updated by the relevant user there is a need to store sufficient information about the user and the reaction. In system 1, should a user update a reaction type then certain parameters are automatically reset, and the below API parameters are utilised:

{

“action” : “haha”,
“hide” : 0,
“isAnonymous” : 0

}

“action” defines the updated type of reaction the user has selected
“hide” defines whether the updated type of reaction should be hidden on the logged in user's account
“isAnonymous” defines whether the updated reaction has been made as an anonymous reaction

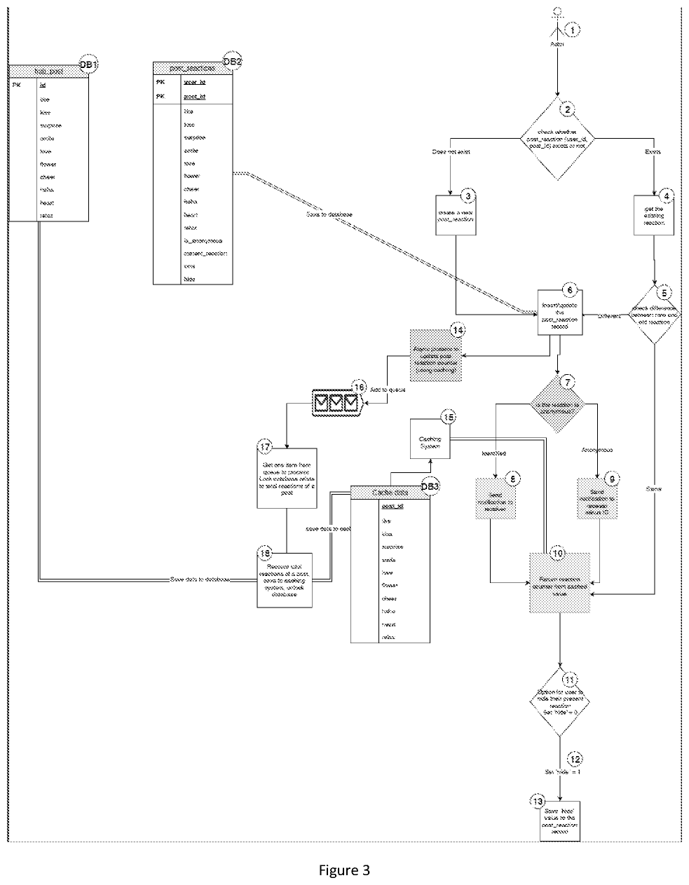

To better illustrate the operation of system 1, reference is made to the flowchart in FIG. 3. The reference numerals 1 to 18 as used to indicate steps in that flowchart are expanded upon below.

Step 1—The Actor (that is, user 3) is presented with the option to provide a reaction 4 to posted content.

Step 2—The user 3 selects a reaction from a predetermined list of reaction types. Upon selection, device 5 passes the reaction type to system 1 via an API. It will be appreciated that prior to passing the reaction type to system 1 the API will have determined if user 3 had previously posted a reaction for the posted content.

At system 1, in response to receiving reaction 4, data 22 is updated to include a table for the reaction based upon the following table structure:

[symbol]

post_reactions

| | |
|---|---|
| PK | user id |
| PK | post id |
| | like |
| | kiss |
| | surprise |
| | smile |
| | love |
| | flower |
| | cheer |
| | haha |
| | heart |
| | relax |
| | is_anonymous |
| | current_reaction |
| | time |
| | hide |

In determining if the user 3 has previously submitted a reaction for the posted content, the API executes the following:
$cur_react_sql=“SELECT*FROM post_reactions WHERE user_id=? and post_id=?”;
$ret=self::fetchRow($cur_react_sql, [$userId, $postId]);

Step 3—If user 3 had not previously submitted a reaction 4 in respect of the posted content system 1 creates a new reaction record (data 22) for the posted content and then progresses to Step 6. Step 3 includes, in more detail:

if (empty($ret)) {

$sql = ″INSERT INTO post_reactions

```
  (‘user_id‘,
  ‘post_id‘,
  ‘{$react−>action}‘,
  ‘is_anonymous‘,
  ‘current_reaction‘,
  ‘time‘,
  'hide')
VALUES (?,?,?,?,?,?,?)″;
```

self::executeStatement($sql, [$userId, $postId, 1, $isAnonymous,

$react−>action, time( ), $isHide]);

$this−>updateReactCounter($postId, $react−>action);
$react−>id = self::lastId( );
$reactId = $react−>id;
}

Step 4—If the user 3 had previously provided a reaction 4 to the posted content, system 1 then determines the existing reaction type by executing the following:

Else if (!empty($ret)) { # If existing record in db

$lastReact = null;
if (!empty($ret[′current_reaction′])) {

$lastReact = $ret[′current_reaction′];

}
$this−>resetReact($userId, $postId);
$this−>updateReactCounter($postId, $react−>action, $lastReact);
if (isset($react−>hide)) {

$hide = ″,‘hide‘ = $isHide ″;

}
$sql = ″

```
UPDATE post_reactions
SET
  ‘{$react−>action}‘ = 1,
  ‘current_reaction‘ = ′{$react−>action}′,
  ‘is_anonymous‘ = $isAnonymous,
  ‘time‘ = ?
  $hide
WHERE user_id = ?AND post_id = ?″;
```

self::executeStatement($sql, [time( ), $userId, $postId]);
$reactId = $ret[′id′];

}

Step 5—System 1 here determines whether the most recently selected reaction by the user 3 is the same as the previously recorded reaction. If the most recently selected reaction is the same as the previously recorded reaction, then nothing is determined to have changed and system 1 proceeds to Step 10. However, to fully complete this step, system 1 returns data to device 5 to inform the user 3 of a successful reaction being posted. This is particularly useful for allowing the user to override an existing hidden reaction. For example, if the user ‘likes’ an item of posted content, then hides the ‘like’ status, and then later returns and ‘likes’ the same posted content, then the most recently selected reaction for that posted content is updated and not skipped. If the most recently selected reaction is the same as the previously recorded reaction are differed, then system 1 advances to Step 6. This is illustrated by the following:

if (!empty($ret[‘current_reaction’])) {

$lastReact = $ret[‘current_reaction’];

}

Step 6—If a new reaction or a varied reaction from a previous reaction has been activated by the user then this post reaction needs to be recorded. The recording of the post reaction is done in at Step 6 using the DB2 database structure and the below statements.

$sql = ″INSERT INTO post_reactions

```
  (‘user_id‘,
  ‘post_id‘,
  ‘{$react−>action}‘,
  ‘is_anonymous‘,
  ‘current_reaction‘,
  ‘time‘,
  ‘hide‘)
VALUES (?,?,?,?,?,?,?)″;
```

self::executeStatement($sql, [$userId, $postId, 1,

$isAnonymous, $react−>action, time( ), $isHide]);

$sql = ″

```
UPDATE post_reactions
SET
  ‘{$react−>action}‘ = 1,
  ‘current_reaction‘ = ′{$react−>action}′,
  ‘is_anonymous‘ = $isAnonymous,
  ‘time‘ = ?
  $hide
WHERE user_id = ?AND post_id = ?″;
```

self::executeStatement($sql, [time( ), $userId, $postId]);
$reactId = $ret[′id′];

After the post reaction has been recorded there are two concurrent or practically concurrent tasks implemented by system 1. This includes undertaking Step 7 to determines whether the reaction was made with an anonymous status attribute, and Step 14 to synchronise and cache the user's reaction response.

Step 7—The user 3 has the unique ability to choose whether the reaction appears anonymous or if it is identified to other users of system 1. At Step 7, the anonymous or identified status of the reaction is reviewed and processed. It should be noted that the user 3 is able to select an anonymous status for the reaction prior to Step 6 and that an anonymous status is also recorded at Step 6. At Step 7 there is a review of that status to complete the process and return data to the user 3. This includes executing the following:
$isAnonymous=(int)@$react->isAnonymous;
$this->updateReactActivity($postId, $userId, $newReaction, $isAnonymous);

Step 8—If the reaction is identified then a notification is sent to the device 5 of the owner of the posted content. This is to alert the owner (typically also a user of system 1) of a new reaction having been made to the posted content. As the user making the reaction has elected to be identified, an indication of the identity of the user (be that a handle, username, avatar or other icon) is available for viewing by the owner. This includes system 1 executing the following:

$notiRepo = new NotificationRepository( );
$ur = new UserRepository( );
$user = $ur−>getById($reactor);
$userName = $user−>firstName . “ ” . $user−>lastName;
if (empty(trim($userName))) {

$userName = $user−>userName;

}
$content = [

‘push’ => [

‘message’ => “$userName has reacted to one of your posts.”,
‘custom’ => [‘type’ => ‘feed_comment’, ‘id’ => $postId]

]

];
$notiRepo−>saveCronNotification($post−>userId, ‘push’, ‘feed_react’,
$reactor . “010101” . $postId, $content);

Step 9—If the reaction has an anonymous status then a notification is sent to the owner of the posted content notifying that owner of the new reaction. The identity of the user providing the reaction is not provided, and a generic “anonymous user” tag or icon is provided. This is done by system 1 operating as follows:

$notiRepo = new NotificationRepository( );
$ur = new UserRepository( );
$user = $ur−>getById($reactor);
$userName = $user−>firstName . “ ” . $user−>lastName;
if ($isAnonymous) {

$userName = ‘An anonymous person ’;

}
$content = [

‘push’ => [

‘message’ => “$userName has reacted to one of your posts.”,
‘custom’ => [‘type’ => ‘feed_comment’, ‘id’ => $postId]

]

];
$notiRepo−>saveCronNotification($post−>userId, ‘push’, ‘feed_react’,
$reactor . “010101” . $postId, $content);

Step 10—System 1 determines the total number of reactions (total count, and count of each reaction type) for the relevant posted content before passing the final count data to the user that made reaction 4. This provides that user with an accurate and updated reflection of the count data for the reactions for the relevant posted content. To implement this, system 1 sends a request to caching system 15 and retrieves the most recent count data for the reactions. This is achieved by executing the following:

return $this−>getReactCounter($postId);

public function getReactCounter($postId) {
$cur_react_sql = ″SELECT

‘like‘,
‘kiss‘,
‘surprise‘,
‘smile‘,
‘love‘,
‘flower‘,
‘cheer‘,
‘haha‘,
‘heart‘,
‘relax‘ FROM hub_post WHERE id = ?″;

$ret = self::fetchRow($cur_react_sql, [$postId]);
$cacheManager = New CacheManager( );
foreach ($ret as $react) {

$ret[$react[′type′]] = $cacheManager−>getReactCount($postId,
$react[′type′]);

}
return $ret;

}

Step 11—Once the user 3 has posted a reaction 4 that user has the option to hide reaction 4 from being displayed within the user account on system 1. That is, user 3 is able to effectively remove any visual confirmation from device 5 that the user has submitted reaction 4. By default, the value of $isHide is equal to the default value of an integer which is 0, resulting in no hidden attribute to the $react object. This is implemented by system 1 as follows:

$isHide=(int)@$react->hide;

Step 12—The user 3 is able to change the hidden status to 1, which results in the visual record of reaction 4 being hidden on the user's account on system 1. Although the reaction remains on system 1 and is included in the computation of the count data for the relevant item of posted content, when viewed from the user's account on system 1 it is as if the user has not made any reaction to the item of posted content. In this embodiment the hidden status cannot be undone, effectively making it impossible for a person to visually detect whether that logged in account has been used to provide a reaction 4 to an item of posted content.

At Step 11, if the any integer is different from 0, then the value will be converted to 1. This results in $react->hide being executed and $isHide being set to 1.

Step 13—If Step 12 has been actioned by the user then a record of that update is be recorded by system 1 as follows:

$sql = ″INSERT INTO post_reactions

```
  (‘user_id‘,
  ‘post_id‘,
  ‘{$react−>action}‘,
  ‘is_anonymous‘,
  ‘current_reaction‘,
  ‘time‘,
  ‘hide‘)
VALUES (?,?,?,?,?,?,?)″;
```

self::executeStatement($sql, [$userId, $postId, 1, $isAnonymous,
$react−>action, time( ), $isHide]);

The above code is used to save the ‘hide’ property of the reaction into the database so that whenever a user retrieves data from the server the server will return this value to determine whether the logged in user had chosen to hide that reaction or not.

Step 14—As soon as Step 6 has been completed the result is forwarded to an asynchronisation process. This process is included so that the user is able to avoid wait times on the reaction being recorded. It also better avoids lock-up of the database as multiple users are posting/changing reactions on the same post at the same time. By the time the operation of system 1 has advanced to Step 14, the unique reaction (userID/postID) record has already been saved to the database. This asynchronisation process is for calculating the new total reactions for a post in cached status. The task asyncUpdatingReactions is described in more detail at Step 18 below. Broadly, system 1 progresses as follows:
$asyncManager=new AsyncManager( );
$asyncManager->runAsyncTask(‘asyncUpdatingReactions’, $postId);

Step 15—In this embodiment the cached data intentionally has a very simple database structure and is exemplarily illustrated in FIG. 3 are the table structure DB3. At Step 15 the relevant data is cached, where that data includes only the bare minimum details such as the post_id, the reaction types and the count of each reaction type, to ensure system 1 is able to transfer those results quickly to the user.

Step 16—Once the reaction or change of reaction made by the user 3 has been accepted by the asynchronisation process it is added to a queue of such reactions/changes. This allows system 1 to orderly accommodate multiple userID/postID that have been made at or close to the same time.

At Step 17, system 1 processes on a FIFO basis each item in the queue formed at Step 16. Each time a reaction in the queue is processed successfully and recounted (at Step 18) then system 1 retrieves the next pending reaction in the queue to process. The database regarding post reactions per post is temporarily locked until successfully updated and progresses as follows:

public function updateReactCounter($postId, $increase = null, $decrease = null) {

```
  $sql = ″START TRANSACTION;
  BEGIN;″;
```

self::executeStatement($sql); # execute this sql will start a transaction, which

lock the table hub_post from being updated until this transaction is committed

if (!empty($increase)) {

$sql = ″UPDATE hub_post SET ‘$increase‘ = ‘$increase‘ + 1 where id = ?″;
self::executeStatement($sql, [$postId]);

}
if (!empty($decrease)) {

$sql = ″UPDATE hub_post SET ‘$decrease‘ = ‘$decrease‘ − 1 where id = ?″;
self::executeStatement($sql, [$postId]);

}
$sql = ″COMMIT;″;

self::executeStatement($sql); # execute commit sql will release the table lock,

by this time the record has been updated allowing other process to access hub_post for
updating further reaction counts
}

For Step 17, use is made of the data structure DB1 illustrated in FIG. 4.

Step 18—After Step 17 has been completed then system 1, at Step 18, recalculates the total count of reactions for the relevant item of posted content, updates the caching system with the new data and unlocks the database so that the next item in the queue is able to be processed at Step 17. The cached data is then stored by system 1 inside the DB3 database structure. This includes system 1 operating at follows:

public function asyncUpdatingReactions($postId) {

$cacheManager = new CacheManager( );
$reactions = $this−>calculateReactions($postId);
foreach ($reactions as $react) {

$cacheManager−>setReactionCache($postId, $react[‘type’],
$react[‘value’]);

}
return true;

Advantages offered by the preferred embodiments include:
Allowing users to post reactions to posted content on an online social media platform, with the option of the user designating that a reaction be anonymous.
Allowing users to post reactions to posted content on an online social media platform, with the option with the option of the reaction being non-detectable to a third party viewing a user history from within the user's account on the platform, or as a separate user making use of his, her or its own account on the platform.
Allowing multiple statuses to be associated with a single reaction.
Allowing a reaction to be identifiable or anonymous at the discretion of the user posting the reaction.
Allowing the status of a reaction to be hidden/made non-detectable at the discretion of the user posting the reaction.
A data structure that obviates problems associated with race conditions on a platform offering comment functionality.
Reducing delays in loading comments and fulfilling requests from users for posted data.
Providing a data structure that allows additional commenting functionalities on a social media platform.
A dynamic reaction environment where users are able to update reactions based upon new inputs and in response to changes in relationships and understandings.
Closer to real-time data to users on the comments (reactions) that have been made to posted content. That is, the data structures and operation allow more active user participation without the typical delays of the prior art.
A data structure that allows new operations to be implemented in a way that enables closer to real-time delivery.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Reference is made in this specification to “data elements”. This term is used to describe a single data element such as a text character or file, or strings of text characters, including special characters, and combinations or groupings of files. A plurality of these elements, and combinations of different types of elements, are able to be included in a single message. However, that is not to imply that all the data elements contained within a given message need be all stored together or transmitted together, simply that the message, however stored or transmitted, provides a functional whole when assembled or accessed.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, a touch screen, one or more manually depressible buttons, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, a smart phone, a switch or bridge, or any machine capable of executing a set of instructions (sequential or otherwise) that specify actions to be taken by that machine.

One embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term “coupled” or “connected”, when used in the claims, should not be interpreted as being limited to direct connections only. The terms “coupled” and “connected,” along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” or “connected” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention

1. A system for allowing first users to electronically post with first user devices respective comments relating to posted content provided by a second user with a second user device, the system including:
an interface for:
receiving: the posted content from the second user device; the comments from the respective first user devices; and requests from the user devices for selected posted data; and
allowing the selected posted data to be directed to the user devices in response to the respective requests from those devices;
a database for storing: content data that is derived from the posted content, wherein the content data includes a content field that is indicative of the content and a count field for storing count data; and comment data that is derived from the comments;
a count engine that is responsive to the interface receiving comments from the respective first user devices for selectively: determining a count of the comments made by the first users; and updating the count field to be indicative of the count; and
a publishing engine that is responsive to the requests for selected posted data accessing the content data and the comment data to generate the selected posted data.

2. A system according to claim 1 wherein the count engine updates the count field to be the count of the comments.

3. A system according to claim 1 wherein each comment has a comment type that is selected from a predetermined list of comment types and the count engine updates the count data to indicate the number of the comments of at least one of the comment types.

4. A system according to claim 3 wherein the count engine updates the count data to indicate the number of the comments of each comment type selected.

5. A system according to claim 4 wherein the count engine updates the count data to indicate the number of the comments of each comment type.

6. A system according to claim 1 including a comment engine that is responsive to the interface receiving a posted comment from one of the first users in respect of the posted content for:
accessing the database and being responsive to the comment data and/or the content data to ascertain if the one of the first users has an existing comment for the posted content;
if so, comparing the posted comment and the existing comment; and
if the posted comment and the existing comment vary, updating the comment data and the count data.

7. A method for allowing first users to electronically post respective comments relating to electronically posted content of a second user, the method including the steps of:
providing an interface for receiving the content from the second user and the comments from the respective first users and for allowing the users to access posted data;
storing in a database: content data that is derived from the content, wherein the content data includes a content field that is indicative of the content and a count field for storing count data; and comment data that is derived from the comments;
being responsive with a count engine to the interface receiving comments from the respective first users for selectively: determining a count of the comments made by the first users; and updating the count field to be indicative of the count; and
using a publishing engine that is responsive to the content data and the comment data for generating the posted data.

8. A method according to claim 7 including the step of the count engine updating the count field to be the count of the comments.

9. A method according to claim 7 wherein each comment has a comment type that is selected from a predetermined list of comment types and the method includes the step of the count engine updating the count data to indicate the number of the comments of at least one of the comment types.

10. A method according to claim 9 including the step of the count engine updating the count data to indicate the number of the comments of each comment type selected.

11. A method according to claim 10 including the step of the count engine updating the count data to indicate the number of the comments of each comment type.

12. A method according to claim 7 including the step of providing a comment engine that is responsive to the interface receiving a posted comment from one of the first users in respect of the content for:
accessing the database to ascertain if the one of the first users has a previously posted comment on the content; and
if so, ascertaining if the posted comment and the previously posted comment vary; and
if so, updating the comment data and the count data.

13. A data structure for allowing first users to provide respective comments relating to content provided by a second user, the data structure including:
a content field that is indicative of the content provided by the second user; and
a count field associated with the content field for storing count data indicative of a count of the comments made by the first users.

14. A data structure according to claim 13 wherein the count data is derived from the number of the comments.

15. A data structure according to claim 14 wherein each comment has a comment type that is selected from a predetermined list of comment types and the count data is derived from the number of the comments of at least one of the comment types.

16. A data structure according to claim 15 wherein the count data is derived from the number of comments of all the comment types.

17. A data structure according to claim 15 wherein the comment type for a comment is selected by the respective first user.

18. A data structure according to claim 13 wherein the count data is indicative of up to a maximum of one comment each for the respective first users.

19. A data structure according to claim 13 wherein the count field is updated in response to one of the first users providing a respective comment.

20. A system for allowing users to electronically post respective comments with user devices, wherein each comment relates to one of a plurality of items of posted content and the system includes:
an interface for:
receiving from the user devices: the comments; and requests for selected posted data; and
allowing the selected posted data to be directed to the user devices in response to the respective requests from those devices;
a database for storing: content data for each item of posted content that is indicative of the posted content for the respective items; and, for each of the comments, comment data that is indicative of the comment and the user making the comment;
a comment engine that is responsive to the interface receiving comments from the respective users for selectively updating the comment data and the content data; and
a publishing engine that is responsive to the requests for selected posted data for accessing the content data to generate the selected posted data.

21. A system according to claim 20 wherein the content data includes count data and the comment engine is responsive to the interface receiving a comment from one of the users in respect of one of the items for: determining a count of the comments made by the users for that item; and updating the count data to be indicative of the count.

22. A system according to claim 21 wherein:
each comment has a comment type that is selected from a predetermined list of comment types; and
the comment engine updates the count data to be indicative of a count of the comments of at least one of the comment types.

23. A system according to claim 22 wherein the comment engine updates the count data to be indicative of a count of the comments of each comment type selected by the users in respect of the one of the items.

24. A system according to claim 22 wherein the count engine updates the count data to indicate a count of the comments of each comment type for the one of the items.

25. A system according to claim 20 wherein the comment engine is responsive to the interface receiving a new comment from one of the users in respect of one of the items of posted content for:
accessing the database to ascertain if the one of the users has provided an earlier comment in respect of the one of the items;
if so, comparing the new comment and the earlier comment; and
being responsive to the comparison for selectively updating the user data.

26. A system according to claim 25, wherein the comment engine is responsive to the comparison for selectively updating the count data.

27. A method for allowing users to electronically post respective comments with user devices, wherein each comment relates to one of a plurality of items of posted content and the method includes the steps of:
providing an interface for:
receiving from the user devices: the comments; and requests for selected posted data; and
allowing the selected posted data to be directed to the user devices in response to the respective requests from those devices;
storing in a database: content data for each item of posted content that is indicative of the posted content for the respective items; and, for each of the comments, user data that is indicative of the comment and the user providing the comment;
being responsive to the interface receiving comments from the respective users for selectively updating the user data; and
being responsive to the requests for accessing the content data and the user data to generate the selected posted data.

28. A data structure for allowing users to electronically post respective comments with user devices, wherein each comment relates to one of a plurality of items of posted content and the data structure includes:
content data for each item of posted content that is indicative of the posted content for the respective items; and
for each of the comments, user data that is indicative of the comment and the user making the comment.

29. A data structure according to claim 28 wherein the content data for each item includes count data that is indicative of a count of the comments made by the users for that item.
